(19) United States
(12) Patent Application Publication
(10) Pub. No.: US 2006/0185517 A1
(43) Pub. Date: Aug. 24, 2006

(54) Multi-stage odor scrubber

(76) Inventor: Daniel J. Nagel, Ottsville, PA (US)

Correspondence Address: D'AMBROSIO & ASSOCIATES, P.L.L.C., 10260 WESTHEIMER, SUITE 465, HOUSTON, TX, 77042, US

(21) Appl. No.: 11/063,157

(22) Filed: Feb. 22, 2005

(51) Int. Cl. B01D 47/00

(52) U.S. Cl. 96/275

(57) ABSTRACT

A multi-stage odor scrubber comprising a first stage odor scrubber comprising a first contact chamber, a first sump for collecting liquids and a first recirculation pump. The multi-stage scrubber further comprises a second stage odor scrubber, the second stage odor scrubber comprising a venturi chamber with one or more venturi adjacent the first contact chamber, and a third contact chamber. The venturi chamber is positioned between the first and third contact chambers. A unitary housing contains the first and second stage odor scrubbers. The second stage odor scrubber further comprises a second sump for collecting liquids from the venturi chamber and the third contact chamber, and a second recirculation pump for re-circulating liquid. A method for removing contaminants from a gas stream comprises propelling a contaminated gas stream through the multi-stage odor scrubber.

### FIELD OF THE INVENTION

The present invention relates to a multi-stage odor scrubber and method for removing contaminants from a gas stream. In one aspect of this invention, the present invention relates to an odor scrubber comprising two contact chambers with a venturi positioned between the two contact chambers.

### BACKGROUND

Gas streams that are released to the atmosphere are scrubbed to remove hazardous pollutants and undesirable odor producing chemicals prior to release. Industrial plants must comply with increasingly stringent EPA requirements to control emissions of odors, air pollutants, and volatile organic compounds. Scrubbing a contaminated gas stream with a liquid reagent solution removes contaminants.

Scrubbers use the process of absorption to purify the contaminated gas stream. Absorption purifies the gas by separating contaminants from the gas stream. This is accomplished by dissolving or absorbing the contaminants in a liquid. The gaseous impurities can either form a physical solution with the liquid or, depending on the mixture, chemically react with a reagent in the liquid.

Typically, scrubbers comprise a housing with one or more hollow chambers. The contaminated gas stream enters at the bottom of the chamber and then travels upward through the chamber. The liquid stream usually enters the top of the chamber and travels downward naturally by the pull of gravity. The opposing directions of the gas and liquid flow paths is known as counter-current flow, which, in certain scrubbers, can increase efficiency. Packing material is often added to the scrubber chamber to maximize contact between the gas and liquid, thus promoting maximum absorption of the gas impurities.

A gas stream having impurities enters the scrubbing chamber. The contaminants are absorbed by the liquid stream and exit the bottom of the chamber with the liquid waste stream. Purified gas leaves the top of the scrubber. The liquid stream is then collected in a sump below the chamber where it can be recycled to the top again along with some make-up reagent to compensate for the reagent consumed in the first pass on the liquid through the chamber. The liquid is re-circulated because the volume of reagent required to absorb the impurities may not be enough alone to wet the entire area required to contain the volume of the gas stream. However, when recirculation occurs in a single tower, the advantage of countercurrent action is largely lost. This can be overcome by the use of several shorter towers with makeup liquid flowing from tower to tower countercurrent to the flow of gas. If the reagent rate is small compared to the recirculation rate, the change in concentration of the contaminant from the top to the bottom of any one tower will be small, so that it is not as important to have countercurrent flow in each tower, and the gas can pass alternately up and down through successive towers. Thomas Sherwood & Robert Pigford, Absorption and Extraction 218 (2d ed. 1952). Using excess reagent would be wasteful and costly. Recycling the liquid stream and adding just enough make-up reagent to absorb the impurities allows the entire gas contact area to be wetted without wasting the reagent. This process is performed continuously to allow for a constant flow of contaminated gas through the scrubber and a constant flow of make-up reagent.

The single packed chamber with counter-current liquid-gas flow is known in the art as a stage. Theoretically, a single stage could remove most of the contaminants in the gas stream if the liquid were not re-circulated and if the packing material were deep enough to allow perfect mixing of the liquid and gas streams. Dan Nagel, What Is a Scrubber Stage?, EST Corporation. However, in actuality the reagent rate is often too low to effectively wet the packing, and the depth of the packed bed is limited by the natural actions of the liquid stream and practical height limitations. Id. Therefore, efficiencies of a single stage are limited. Id. To achieve contaminant removal greater than the single stage limit, several stages can be used in series, with the contaminated gas stream exiting the top of one stage and entering the bottom of another. Id.

An example of a scrubber system using packed beds is disclosed in Jain et al., U.S. Pat. No. 6,174,498, which describes an odor scrubber comprising a unitary housing enclosing three chambers where the liquid treatment of an odor causing gas stream occurs. The gas stream changes flow direction to flow in the opposite direction of the adjacent chamber. Treatment liquids are delivered to each chamber from two separate sumps. The second sump delivers liquids to both the second and third chamber. In all embodiments, all three chambers comprise either packed beds or simple spray chambers.

Jain, U.S. Pat. No. 5,518,696 discloses another scrubber system comprising an emergency scrubber system for the treatment of a noxious fluid released from pressurized storage containers in a storage room. The emergency scrubber system guides escaping noxious fluids through an irregular non-linear path, which may contain packing, while treating the fluid. In one embodiment, a fan draws the gasses through a fluid conditioning stage for treatment. The noxious gas is drawn through a wire mesh that is wetted by the treating substance.

Finally, Davis, U.S. Pat. No. 4,948,402, discloses a modular air scrubber system for removing pollutants from air. The system is comprised of individual scrubbing towers that are adapted for side-by-side interconnection and disconnection. The interconnected modules provide multi-stage treatment of the polluted air stream with treatment liquid. Each tower comprising a reservoir, an air inlet, an air outlet, a scrubber solution inlet, a scrubber solution outlet, and an L-shaped housing. Each tower also comprising contact media in the upper portion of the tower. These apparatus use beds of packing media or an empty chamber within the scrubber to facilitate the absorption of the contaminants.

A significant need exists for an odor scrubber in a unitary housing which improves the contact between the contaminated gases and the absorption reagents and minimizes the use of the reagents.

### SUMMARY

The present invention provides a multi chamber, multi-sump odor scrubber with improved removal of contaminants from a gaseous stream. In one embodiment of this invention, contaminant removal is enhanced by the use of a venturi in the middle chamber of the three chamber system. This is an important improvement as it allows efficient absorption of contaminants through co-current treatment of the gas stream. Advantageously, having the venturi in the middle chamber allows the most efficient use of the three chamber, two sump odor scrubber because it allows downward gas flow in the venturi chamber to be efficiently mixed with the downward flowing treatment liquid as the liquid is sprayed out from the venturi nozzle. The odor scrubber of this invention removes approximately 90% of the contaminants from the gas stream in the first chamber, about 9% in the venturi chamber and any remaining small amount of contaminants is removed in the third chamber. Because the middle chamber venuri is more efficient in removing contaminants than the third chamber, the design of the present invention allows a greater percentage of the treatment liquids to be directed to the venturi chamber than the third chamber.

In one embodiment of this invention, a multi-stage odor scrubber comprises a first stage odor scrubber and a second stage odor scrubber. The first stage odor scrubber has a first contact chamber, a means for piping contaminated gases into the first contact chamber, a first packed bed within the first contact chamber, first chamber spray nozzles for spraying liquid into the first packed bed, a first sump for collecting liquids and a first recirculation pump. The second stage odor scrubber comprises a venturi chamber adjacent the first contact chamber, and a third contact chamber, the venturi chamber positioned between the first and third contact chambers, the venturi chamber comprising one or more venturi. In this multi-stage scrubber, the third contact chamber comprises a second packed bed and third chamber spray nozzles for spraying liquid into the third contact chamber. The venturi chamber has venturi spray nozzles for spraying liquid into one or more venturi. Preferably, the second stage odor scrubber further comprises a second sump for collecting liquids from the venturi chamber and the third contact chamber, a wall between the first sump and the second sump, and a second recirculation pump for re-circulating liquid into the venturi spray nozzles and the third contact chamber spray nozzles.

In another aspect of this embodiment, the first contact chamber comprises an upper and a lower section and the means for piping contaminated gases into the first contact chamber is located in the lower section. The first contact chamber and venturi define an opening between them. Gases piped into the first chamber flow upward and through the opening so that gases from the first contact chamber flow into a top section of the venturi chamber. The one or more venturi fit snugly within the venturi chamber so that gases entering from the first contact chamber enter the one or more venturi. The second stage odor scrubber defines a passageway beneath the venturi and third contact chamber. Treated gases exiting from the venturi flow through the passageway into bottom of the third chamber.

The multi-stage scrubber of this invention further comprises a first liquid recirculation line from the first sump to the first contact chamber for re-circulating liquid in the first sump to the first chamber spray nozzles. Preferably, a first make-up line is in fluid communication with the first liquid recirculation line for conveying make-up liquids to the first contact chamber. A second liquid recirculation line leads from the second sump to the venturi for re-circulating liquid in the second sump to the venturi spray nozzles. A connecting pipe, located between the first and second sump, interconnects the first sump and the second sump for purging spent liquids from the scrubber and transferring excess and unused liquids or reagents forward from the second sump to the first sump.

In another aspect of this embodiment, the third chamber spray nozzles comprise a diameter smaller in size than the diameter of the venturi spray nozzles so that a greater volume of liquid from the second liquid recirculation line enters the venturi spray nozzles than the volume of liquid entering the third chamber spray nozzles. Alternatively, a second piping means leads from the second liquid recirculation line to the third contact chamber spray nozzles for conveying re-circulating liquids to the third chamber spray nozzles. The second piping means comprises a diameter smaller in size than the diameter of the second liquid recirculation line so that a greater volume of liquid enters the venturi spray nozzles than the volume of liquid entering the third chamber spray nozzles.

Odor scrubbers are necessary because gases can comprise one or more contaminants. The liquid sprayed into the venturi chamber and first and third contact chambers comprises reagents for removing theses contaminants. As reagent liquids are used up in the decontamination of the gases, make-up liquid reagents must be added. One or more make-up liquid lines can be in fluid communication with the second piping means for conveying make-up liquids to the third contact chamber. Alternatively, the one or more make-up lines are in fluid communication with the second liquid recirculation line for conveying make-up liquids to the venturi chamber and the third contact chamber.

Preferably, the first contact chamber and the third contact chamber each comprise a mist eliminator for removing entrained droplets from the gases prior to the gases leaving the first contact and third contact chamber, respectively. The third contact chamber further defines a discharge outlet for discharging scrubbed gases. When the gasses have traveled through the three chambers, they are cleansed of contaminants to an acceptable level of impurities, typically about 99% contaminant-free. One feature of this invention that accomplishes that low level of impurities is that the flow of gas in the first contact chamber and third contact chamber is counter-current to the flow of liquid and the flow of gas in the venturi chamber is co-current with the flow of liquid.

In one embodiment of this invention, the diameters of the venturi spray nozzles and the third chamber spray nozzles are sized to allow approximately 80% of the liquid from the second liquid recirculation line to flow into the venturi spray nozzles and 20% to flow to the third chamber spray nozzles. Alternatively, the second piping leading to the third contact chamber is smaller in diameter than the second liquid recirculation allowing approximately 80% of the liquid from the second liquid recirculation line to flow into the venturi spray nozzles and 20% to flow into the second piping leading to the spray nozzles of the third chamber.

In another embodiment of the multi-stage odor scrubber, the odor scrubber comprises three stages:

1. a first stage odor scrubber, the first stage odor scrubber comprising a first contact chamber, means for piping contaminated gases into the first contact chamber, a first packed bed within the first contact chamber, first chamber liquid spray nozzles for spraying liquid into the first packed bed, a first sump for collecting liquids, a first liquid recirculation line for conveying re-circulating liquids and make-up liquids to the first chamber spray nozzles and a first recirculation pump.

2. a second stage odor scrubber, the second stage odor scrubber comprising a second contact chamber, means for piping contaminated gases into the second contact chamber, a second packed bed within the second contact chamber, second chamber liquid spray nozzles for spraying liquid into the second packed bed, a second sump for collecting liquids, a second liquid recirculation line for conveying re-circulating liquids and make-up liquids to the second chamber spray nozzles and a second recirculation pump;

3. a third stage odor scrubber, the third stage odor scrubber comprising a third contact chamber, means for piping contaminated gases into the third contact chamber, a third packed bed within the third contact chamber, third chamber liquid spray nozzles for spraying liquid into the third packed bed, a third sump for collecting liquids, a third liquid recirculation line for conveying re-circulating liquids and make-up liquids to the third chamber spray nozzles and a third recirculation pump;

The three-stage odor scrubber advantageously comprises a unitary housing for containing the first stage odor scrubber, the second stage odor scrubber and the third stage odor scrubber. Preferably, the three stage odor scrubber also comprises a first wall between the first and second sumps, a second wall between the second and third sumps, a first connecting pipe between the first sump and the second sump and a second connecting pipe between the second sump and the third sump for purging spent liquids from the scrubber and conveying excess and unused liquids forward from the third sump to the second sump, and from the second sump to the first sump. This embodiment further comprises the additional design innovations as described in the previous embodiments.

One preferred embodiment of this invention comprises a method for removing contaminants from a gas stream by propelling a contaminated gas stream through a multi-stage odor scrubber. In this method, the multi-stage odor scrubber comprises two stages. The first stage comprising a first packed chamber and the second stage comprising a second packed chamber, and a venturi chamber between the first and third chambers. The venturi chamber comprises one or more venturi and venturi spray nozzles for each venturi. In the method, the contaminated gas entering the first contact chamber is propelled upwardly through the first packed chamber so that the gas exits from a slot within an upper wall of the first chamber into the top of the venturi chamber. The gas then flows downward through the venturi, co-currently with the liquid from the venturi spray nozzles. The partially scrubbed gas from the venturi is then propelled to the bottom of the venturi chamber. From there, the gas flows through the passageway to the second packed chamber and moves upwardly through it. The gas flow in the second packed chamber is counter-current to the flow of the liquid.

Embodiments of the method include the following features. Reagent liquid is preferably piped upward through a first liquid reagent line from a first sump to the first chamber spray nozzles within a top section of the first packed chamber. It is then sprayed into the chamber. This is done in a manner counter-current to the gas so that the liquid flows downward through the packed chamber as the gas flows upward. The liquid reagents wet the gases so that they absorb or otherwise react with the contaminants. The unused and spent liquids continue downward and collect in the first sump. Additional reagent liquid can also be pumped from a second sump through a second liquid recirculation pipeline to the venturi spray nozzles within the top section of the venturi chamber so that the one or more reagent liquids flow co-currently to the gas and collect in the second sump. A portion of this reagent fluid is then piped from the second liquid recirculation line to the third chamber spray nozzles within the top of the third contact chamber. This portion of the reagent fluid is smaller than the portion entering venturi spray nozzles. Another advantage of this invention is that, because the bulk of the reagent is supplied to the venturi as a result of the higher liquid rate, the more costly reagents are used more efficiently. Make-up liquid can be added to the first liquid recirculation line and either to the second liquid recirculation pipeline before the flow of liquid into the third contact chamber or to the second piping or pipeline leading from the second recirculation line to the third contact chamber.

The reagent liquid is allowed to flow downward from the spray nozzles within the venturi chamber and the third contact chamber. The reagent liquid collects within the second sump for recirculation back to the spray nozzles. The gas is propelled upward in the first packed chamber so that the gas exits from a slot within the first packed chamber into the top of the venturi chamber. The gas then flows downward through the venturi, co-currently with the liquid from the venturi spray nozzles. The partially scrubbed gases are then propelled from the venturi chamber to the bottom of the third contact chamber so that the gas flows upwardly through the third contact chamber. This flow is counter-current to the liquid flow in the third contact chamber. Make-up liquid can be added to the first contact chamber. Make-up liquid is also added to the re-circulating liquid pipeline before the flow of liquid into the third contact chamber.

In another method of this invention as used with a three stage odor scrubber, gases are propelled upward in the first contact or packed chamber so that the gas exits from a slot within the first packed chamber into the top of the second chamber. The gas then flows downward through the second contact chamber, co-currently with the liquid from the second contact chamber spray nozzles. The partially scrubbed gases are then propelled from the second contact chamber to the bottom of the third contact chamber so that the gas flows upwardly through the third contact chamber. This flow is counter-current to the liquid flow in the third contact chamber. Reagent liquids flow upward through liquid recirculation lines from each of the three sumps to their respective spray nozzles. The reagent liquids wet the packing within the contact chambers as they flow downwards. Make-up liquids are added to as the reagents are spent.

### BRIEF DESCRIPTION OF THE DRAWINGS

FIG. 1 is a schematic of one embodiment of the odor scrubber of this invention illustrating a venturi middle chamber.

FIG. 1A is another schematic of FIG. 1 illustrating another embodiment of the odor scrubber.

FIG. 2 is a side view of the odor scrubber illustrated in FIG. 1.

FIG. 3 is a schematic of another embodiment of the odor scrubber of this invention illustrating a packed chamber as the middle chamber.

### DETAILED DESCRIPTION

The present invention provides a multi-stage odor scrubber with improved removal of contaminants from a gaseous, odorous stream. In one embodiment of this invention, the odor scrubber is a wet scrubber. The wet scrubber of this invention physically or chemically absorbs gases into water or other liquids, such as solutions of caustic, bleach or acid. These reagents absorb contaminants from gas streams through contact with the gas. The odor scrubber preferably comprises a multi-stage, three chambered system within a unitary housing.

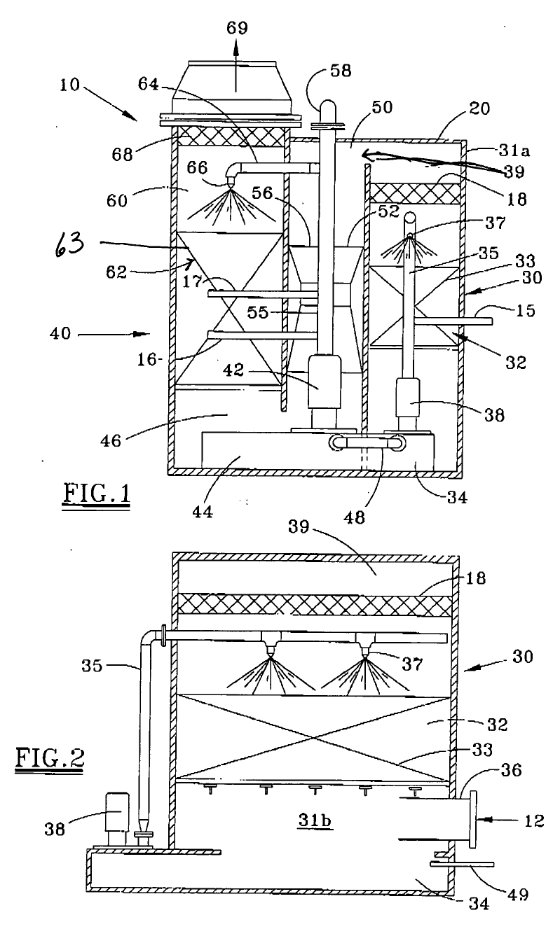

Referring to FIG. 1, in one embodiment of this invention, contaminant removal is enhanced by the use of a venturi 52 in the middle chamber 50 of the three chamber system 10. This is an important improvement as it allows efficient absorption of contaminants through co-current treatment of the gas stream, that is, the gas stream and liquid treatment reagents flow in the same direction. The energy in a motive fluid as created by the venturi is used to entrain and remove noxious gases, fumes, and dusts from a contaminated gas stream. Advantageously, having the venturi in the middle or venturi chamber 50 allows the most efficient use of the three chamber odor scrubber 10 because it allows for a better distribution of expensive reagents within a second stage of the odor scrubber. In this embodiment of the invention, the multi-stage odor scrubber comprises a first stage 30 and a second stage 40, each stage capable of independently removing contaminants from a gas stream. To that end, the first stage 30 has a first contact chamber 32, a first sump 34 for collecting liquids, and a first recirculation pump 38. The second stage 40 of the odor scrubber 10 comprises a venturi chamber 50 and a third contact chamber 60. The venturi chamber 50 can comprise one or more venturi 52. In one embodiment, the venturi is an ejector venturi. The venturi chamber 50 is positioned between the first contact chamber 32 and the third contact chamber 60.

A unitary housing 20 contains both the first and second stages 30, 40 of the odor scrubber 10. The housing can be fabricated from corrosion-resistant materials such as industrial grade fiberglass reinforced plastic since acids and caustics are used as liquids. The housing 20 encloses both stages of the odor scrubber 10. The second stage 30 having two chambers 50, 60, also comprises a second sump 44 for collecting the liquids from both chambers 50, 60 and a second recirculation pump 42 for re-circulating liquid. In an alternative embodiment, not shown, the multi-stage odor scrubber can comprise a first housing for the first contact chamber, a second housing for the venturi chamber and the third contact chamber. The first housing comprises a means for fluid communication with the second housing and the second housing comprising a second means for fluid communication with the third housing.

The chambers 32, 50, 60 are frequently referred to as towers, and in one preferred embodiment of this invention, the first contact chamber and the third contact chamber 32, 60 are packed bed chambers 32, 62. Each packed bed chamber 32, 62 or tower comprises a vertical shell set on an adequate foundation for support. The packed beds 33, 63 comprises inert packing materials that are commonly available under the trade names of Rauschert™ hi-flow rings, Jaeger™ tri-packs, Lantec™ Q-Pac packing.

As an alternative to packing in this invention, a venturi 52 is employed within the middle chamber 50 to provide a better distribution of expensive reagents to the venturi 52 and the third contact chamber 60. The venturi 52 is a convergent cone or pyramid which forms a throat at the bottom followed by divergent cone or pyramid that widens back to the original width of the opening. Contaminated gas is drawn into the venturi 52 by means of the ejector action of the high velocity liquid spray directed into the venturi throat. The spray impinges on the venturi throat to induce the draft-producing action. As a gaseous stream flows through the venturi 52, the ejector action causes turbulence within the gas stream, promoting absorption of the impurities. The scrubbed gases leave the throat area with the contaminants absorbed into the scrubbing liquid. The most effective method of using the venturi 52 in liquid-gas absorption is to spray the liquid into the venturi 52 co-currently to the gas flow, that is, in the same direction as the gas flow path. The co-current flow of the venturi 52 and the counter-current flow within the first and third chambers 32, 60 are used because the venturi 52 works well with a downward gas flow path, while a packed chamber works best with an upward gas flow.

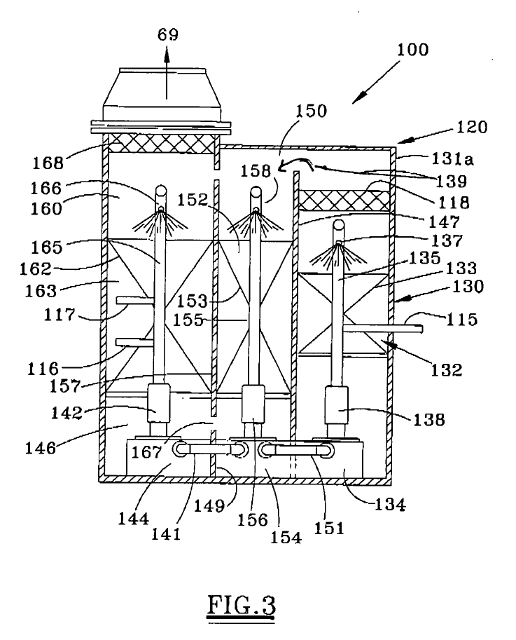

As illustrated in FIGS. 1 and 2, the first stage of the scrubber 30 comprises the first contact chamber 32, a means for piping contaminated gases 36 into the first contact chamber, a first packed bed 33 within the first contact chamber 32, and first chamber liquid spray nozzles 37 for spraying liquid into the first packed bed 33. The means for piping contaminated gases 36 comprise pipes or ducts. The piping means 36 define a gas inlet 12. Contaminated gases enter the gas inlet 12. Fans (not shown) may be used to draw the contaminated gases into the gas inlet 12 of the first stage scrubber 30 so that the gases enter the first contact chamber 32. The multi-stage, odor scrubber of this invention is capable of treating air rates from 250 to 25,000 CFM. The contaminated gases flow upward through the first packed bed 33 in the contact chamber 32. Near the top of the first stage scrubber 30 is the first chamber liquid spray nozzles 37 for spraying liquid into the first packed bed 33. The bottom of the first stage scrubber 30 comprises the first sump 34 for collecting liquids, and the first recirculation pump 38. The first recirculation pump 38 can be a vertical pump.

Liquids are preferably reagent liquids that are pumped from the sump 34 into piping, specifically the first liquid recirculation line 35, which transports the liquid to the one or more liquid spray nozzles 37 at the top of the first packed bed 33. The reagent liquid flows downward from the spray nozzles 37 and counter-current to the gas flow flowing upward from the gas inlet piping 36. The liquid flows from the first set of spray nozzles 37 downward through the column of the first chamber that is filled with the packed bed 33 to provide a large contact area between the liquid and gas for effective removal of gaseous contaminants from the gas stream. Pressure drop in both the liquid and gas is low, so energy usage is low. The first stage scrubber 30 can further comprise a piping means 15 for adding make-up liquids to the first contact chamber 32 by piping them into the first liquid recirculation line 35. Make-up reagent liquids are required as the reagents are used up during the contaminant removal process. In one embodiment, spent reagents are removed from the multi-stage odor scrubber 10 by piping the spent reagents through an interconnecting pipe 48 from the second sump 44 forward to the first sump 34 and purging them from the first sump in an amount equal to the amount of make up liquids that are added.

The first contact chamber 32 comprises an upper section 31a and a lower section 31b. The gas inlet 12 and means for piping 36 contaminated gases into the first contact chamber 32 is located in the lower section 31b. The first contact chamber 32 and venturi chamber 50 define a slot 39 between the venturi chamber 50 and the first contact chamber 32 so that upward flowing gases from the packed bed 33 flow past the spray nozzles 37, out the slot and into the venturi chamber 50. The one or more venturi 52 fit snugly within the venturi chamber as illustrated in FIG. 1 with the top 56 of the venturi in contact with the walls of the venturi chamber 50. In this way, gases entering from the first contact chamber 32 must enter the venturi 52.

The second stage 40 of the odor scrubber 10 comprises a third contact chamber 60 having a second packed bed 63 and a third chamber set of liquid spray nozzles 66 for spraying liquid into the packed bed 63. The second stage 40 also comprises the venturi chamber 50 positioned between the first and third contact chambers 32, 60, and venturi spray nozzles 58 for spraying liquid into the one or more venturi 52. The constriction of the venturi 52 disturbes the flow of gas stream, causing turbulence within the gas. Turbulence increases the mixing of the gas and the liquid supplied by the venturi spray nozzles 58, promoting absorption. In one embodiment of this invention, the system comprises an inlet fan for moving the gas throughout the scrubber to conserve energy. In an alternative embodiment of this invention comprising an ejector venturi scrubber, the ejector venturi creates a draft and can be used without a fan at the cost of increased energy consumption. The third contact chamber 60 and venturi chamber 50 share the second sump 44 for collecting liquids and a second recirculation pump 42 which pumps re-circulating liquid through a second recirculation line 55 into the venturi spray nozzles 58 and the third contact chamber spray nozzles 66.

The second stage 40 of the odor scrubber further comprises a wall 57 between the venturi chamber 52 and the third contact chamber. The wall does not continue to the bottom of the housing. The end of the wall and housing 20 of the odor scrubber define a passageway 46 beneath the venturi 52 and the third contact chamber 60 so that gases exiting from the venturi flow into the third chamber 60. A second liquid recirculation line 55 leads from the second sump 44 to the venturi 52 to pipe re-circulating liquid from the second sump 44 to the venturi spray nozzles 58. In one embodiment, a second piping means 64 runs from the second liquid recirculation line 55 to the third contact chamber spray nozzles 66. In one advantageous embodiment, the second piping means 64 comprises a diameter smaller in size than the diameter of the second liquid recirculation line 55 so that a greater volume of liquid enters the venturi spray nozzles 58 than the volume of liquid that enters the third contact chamber spray nozzles 66. The diameter of the second recirculation line 55 and the second piping means 64 are sized to allow approximately 80% of the liquid from the second sump 44 to flow into the venturi spray nozzles 58 and approximately 20% to flow into the third contact chamber spray nozzles 66. In another advantageous embodiment, the openings of the venturi spray nozzles 58 are larger than the openings of the third contact chamber spray nozzles so that the greater portion of regent liquid enters the venturi 52 then the amount entering the third packed chamber 63. Preferably, approximately 80% of the liquid enters the venturi spray nozzles 58 with the remaining approximately 20% entering the third contact chamber spray nozzles. The scrubber 10 can also comprise one or more make-up lines 16, 17 for conveying make-up reagent liquids to the venturi and the third contact chamber by piping or transporting the make-up liquid to the second recirculation line 55. Alternatively, the one or more make-up lines 16, 17 can enter the second piping means 64 so that the make-up reagent liquids enter the third chamber, flow down into the second sump 44 and then are recirculated to the venturi chamber 50 by the second liquid recirculation line 55. Advantageously, the venturi 52 receives the bulk of the chemical reagents since the venturi remove a greater percentage of contaminants than the third contact chamber.

A wall 51 preferably separates the first sump 34 from the second sump 44 to prevent reagent liquids from the first sump 34 mixing with reagent liquids in the second sump 44. Reagents are used to remove contaminants from the contaminated gases. The odor scrubber 10 can contain two or more sumps 34, 44 for receiving the reagent liquids which are chemical solutions to treat odors and contaminants emanating from wastewater treatment plants, composting sites, and other industrial sites. Caustic and bleach solutions, for example, treat hydrogen sulfide (H₂S) and other sulfur bearing compounds, indoles, skatoles, and other organic compounds. Sulfuric acid solutions may be used to treat ammonia, amines, and other basic compounds. Caustic, such as sodium hydroxide, is used in the first stage 30 because the bulk of the impurities, approximately 90%, are removed during the first stage 30 of the odor scrubber. Caustic is a relatively cheap treating reagent. The caustic is piped from the first sump 34 and up to the spray nozzles 37 of the first contact chamber 32 by means of the first recirculation line 35. Bleach, sodium hypochlorite for example, is used to remove contaminants not removed by the caustic. Since bleach is more costly, a combination of bleach and caustic is piped to the second recirculation line 55 for piping to the venturi spray nozzles 58 and the third contact chamber 60 by means of the second recirculation line 55 and the second piping means 64 to the third chamber spray nozzles 66. Approximately 9% of the remaining contaminants are removed by the venturi system 52 and the remaining approximately 1% of contaminants are removed in the third chamber 60. Therefore, the third chamber 60 receives about 20% of the liquid coming from the second recirculation line 55. Caustics are less expensive than bleach and used in greater bulk in the first stage of the odor scrubber. The more expensive bleach products are used in the second stage. The benefit of this invention is that the greater amount of the bleach, about 80%, is sent to the venturi chamber where the greater amount of the remaining contaminants, approximately 9%, are treated. Liquids flowing through all chambers are re-circulated from the sumps to provide effective contact between the liquids and gas. The effectiveness of the liquid is lost as the contaminants are removed. Sensors determine, by pH or ORP testing, when make-up reagents are required. Make-up liquids are added to the first recirculation line 35 and the second recirculation line 55 as required through the make-up lines 15, 16 and 17 respectively. Alternatively, the one or more make-up lines 16, 17 can enter the second piping means 64 so that the make-up reagent liquids enter the third chamber, flow down into the second sump 44 and then are recirculated to the venturi chamber 30 by the second liquid recirculation line 55. Excess liquid, approximately equal in amount to the added make-up liquid, is purged.

Scrubbed gases exit the scrubber after treatment in the third contact chamber 60. The third contact chamber 60 can further comprise a second mist eliminator 68 for removing entrained droplets from the gases prior to the gases exiting the odor scrubber. The third contact chamber 60 also defines a discharge outlet 69 for discharging scrubbed gases. The flow of the gas in the first and third contact chambers 32, 60 is counter-current to the direction of the liquid flow. The flow of gas through the venturi 52 is co-current with liquid flow. In another embodiment, the first contact chamber can also comprise a first chamber mist eliminator 18 for removing droplets from the gases prior to the gases leaving the first contact chamber 30. The mist eliminator 68 above the third contact chamber 60 works to eliminate droplets in the exiting gases. In one aspect, the odor scrubber 10 has a connecting pipe 48 between the first sump 34 and the second sump 44 so that used reagent liquids flowing downward from the third contact chamber 60 and the venturi 52 into the second sump can flow forward and enter the first sump 34 for recirculation so that unused reagent can be optimized before purging of spent reagent liquids. Amounts of re-circulating liquid approximately equal to the amount of influent make-up reagents are purged periodically through a purge line 49.

FIG. 3 illustrates another embodiment of the multi-stage odor scrubber. In this embodiment, the odor scrubber 100 comprises three stages 130,150, 160 within a unitary housing 120. Each stage of this embodiment comprises a packed tower, a sump and a recirculation line for transporting liquid reagents from the sump to the packed tower. The first stage odor scrubber 130 comprises a first contact chamber 132, a gas inlet 112 for piping contaminated gases into the first contact chamber, a first packed bed 133 within the first contact chamber 132, first chamber liquid spray nozzles 137 for spraying liquid into the first packed bed 133, a first sump for collecting liquids 134, a first liquid recirculation line 135 for conveying re-circulating liquids and make-up liquids to the first chamber spray nozzles 137 and a first recirculation pump 138.

The second stage odor scrubber 150 comprises a second contact chamber 152, the first contact chamber 132 and the second contact chamber 152 defining an opening 139 into the second contact chamber, a second packed bed 153 within the second contact chamber 152, second chamber liquid spray nozzles 158 for spraying liquid into the second packed bed 153, a second sump 154 for collecting liquids, a second liquid recirculation line 155 for conveying re-circulating liquids to the second chamber spray nozzles 158 and a second recirculation pump 156. The third stage odor scrubber 160 comprises a third contact chamber 160. The second and third stage odor scrubbers 150,160 share a common middle wall 157 that ends prior to the area surrounding the sumps 144,154 so that the second and third contact chambers, 152, 162 define a second opening 167 for transmitting gases from the second contact chamber 152 to the third contact chamber 162.

As with the other stages, the third stage 160 further comprises a third packed bed 163 within the third contact chamber 162, third chamber liquid spray nozzles 166 for spraying liquid into the third packed bed 163, a third sump 144 for collecting liquids, a third liquid recirculation line 165 for conveying re-circulating liquids and make-up liquids to the third chamber spray nozzles 166 and a third recirculation pump 142 for pumping the reagent liquids from the third sump 144 to the third recirculation line 165.

The three-stage odor scrubber 100 advantageously comprises a unitary housing for containing the first stage odor scrubber 130, the second stage odor scrubber 150 and the third stage odor scrubber 160. Preferably, the three stage odor scrubber 100 also comprises a first wall 147 between the first and second sumps 134, 154, a second wall 149 between the second and third sumps 154, 144, a first connecting pipe 151 between the first sump 134 and the second sump 154 and a second connecting pipe 141 between the second sump 154 and the third sump 144 for purging spent liquids from the scrubber and conveying excess and unused liquids forward from the third sump 144 to the second sump 154, and from the second sump 154 to the first sump 134. As with the two-stage scrubber, make-up reagent liquids are necessary to replace the spent reagents. The make-up reagents can be added to the recirculation lines, preferably, the first liquid recirculation line 135 and the third liquid recirculation line 165. The excess make-up liquid from the third odor scrubber drops down into the third sump 144 and flows forward through the second interconnecting pipe 141 into the second sump 154 for recirculation through the second contact chamber 152. In an alternative embodiment of the three-stage scrubber, the first and second stages comprise packed chambers and the middle stage comprises a venturi chamber. Each of the three stages has its own sump and recirculation lines.

One preferred embodiment of this invention comprises a method for removing contaminants from a gas stream by propelling a contaminated gas stream through a multi-stage odor scrubber. In this method, the multi-stage odor scrubber comprises two stages as shown in FIG. 1. The first stage 30 comprising a first packed chamber 32 and the second stage 40 comprising a second packed chamber 62 and a venturi chamber 50 between the first and third chambers 32, 62. The venturi chamber 50 comprises one or more venturi 52 and venturi spray nozzles 58 for each venturi. The first and third chambers 32, 60 comprise first chamber spray nozzles 37 and third chamber spray nozzles 66. The venturi chamber 50 comprises one or more venturi 52 and a set of venturi spray nozzles 58 for each venturi 52. Piping or ducting means 36 to the first contact chamber 32 define a gas inlet 12. Contaminated gases enter the gas inlet 12. Fans (not shown) may be used to draw the contaminated gases into the gas inlet 12 of the first stage scrubber 30 In this method, as the contaminated gases enter the first contact chamber 32 they are propelled upwardly through the first packed chamber 32 from the gas inlet and decontaminated by the reagent liquid coming from the first chamber spray nozzles 37.

The reagent liquid is piped upward from the first sump 34 up to the first spray nozzles within the top section of the first packed chamber by means of the first recirculation line 35. This is done in such a manner that the reagent liquid sprayed from the nozzles 37 flows through the packed bed 33 counter-current to the gas, and collects in the first sump 34. The gases are approximately 90% decontaminated after going through the first packed bed 33. The decontaminated gas exits from the first contact chamber 32 by means of a slot 39 within an upper wall of the first chamber 32 into an opening in the top of the venturi chamber 50. The downward flowing reagent liquid collects in the first sump 34 under the first contact chamber 32 for recirculation throughout the first chamber 32. Liquid in the first sump is usually caustic, whereas liquid in the second sump is typically caustic and bleach. In some cases, when the contaminant is ammonia for example, acid, such as sulfuric acid, is re-circulated in the first stage.

Gases entering the venturi 52 then flow downward through the venturi 52, co-currently with the reagent liquid from the venturi spray nozzles 58. The one or more venturi 52 are co-current contactors that naturally have a high liquid to gas ratio therefore improving the efficiency of the decontamination process. The venturi chamber 50 can comprise one or more venturi 52 and a venturi spray nozzle 58 for each venturi 52. The reagent liquid is pumped from a second sump 44 through a second recirculation pipeline 55 to the venturi spray nozzles 58 within the top section of the venturi chamber 50. Since the venturi is more efficient and can treat approximately 9% of the remaining contaminants, the venturi receives approximately 80% of the reagent liquid coming from the second sump 44. A smaller portion of this reagent fluid is then piped from the recirculation pipe line 55 to the third chamber spray nozzles 66 within the top of the third contact chamber 60. The reagent liquid is allowed to flow downward from the spray nozzles 58, 66 within the venturi chamber 52 and the second packed chamber 60. Spent as well as unused reagent liquid collects within the second sump 44 for recirculation back to the spray nozzles 58, 66.

As the re-circulating liquid is pumped to the spray nozzles 58, 66, the partially scrubbed gas is propelled from the venturi chamber 50 to the bottom of the second packed chamber 62 so that the gas flows upwardly through the second packed chamber 62. This flow is counter-current to the liquid flow in the third chamber 60. Because reagents are consumed while removing the contaminants, make-up liquid is added to the second re-circulating liquid pipeline 55 before the flow of liquid into the third contact chamber 60. The makeup liquids can be added to the first and second liquid recirculation lines, or alternatively the first recirculation line and the second piping going to the second chamber spray nozzles. The liquid through the three chambers drops down into the first and second sumps. Interconnecting piping allows the liquid from the second sump to flow forward into the first sump. Excess makeup reagents are then re-circulated through the first contact chamber. Some recirculation liquid and spent reagents are purged in an amount approximately equal to the make up reagent added to the recirculation lines.

Prior technology employed three contact chambers in a two stage arrangement. The first stage or contact chamber in the system consisted of a counter-current packed bed, and the second stage consisted of two contact chambers, the first a co-current packed bed, and the second a counter-current packed bed. Each of the two stages had its own sump and recirculation pump. In the second stage, the recirculation flow was split (presumably equally) between the two packed contact chambers. Relatively inexpensive caustic reagent was fed into the first stage recirculation line. More expensive caustic and bleach (sodium hypochlorite) reagent was fed into the second stage recirculation line before the flow splits to each contact chamber. A drawback of this arrangement is that only half of the expensive bleach reagent was supplied to the first contact chamber of the second stage. Therefore, only half of the compounds that react with bleach can be removed in this contact chamber when minimizing bleach make-up.

In the method of this current invention, this drawback is overcome by replacing the middle contact chamber of the second stage with one or more ejector-venturi 52. The venturi are co-current contactors that naturally have a high liquid to gas ratio. In the present invention, 80% of the second stage recirculation flow is supplied to the venturi, so 80% of the make-up bleach reagent will be available at the venturi. Therefore, up to 80% of the compounds that react with bleach can be removed in the venturi while minimizing the make-up bleach reagent.

In another method of this invention as used with a three stage odor scrubber illustrated in FIG. 3, gases are propelled upward in the first contact or packed chamber so that the gas exits from a slot within the first packed chamber into the top of the second chamber. The gas then flows downward through the second contact chamber, co-currently with the liquid from the second contact chamber spray nozzles. The partially scrubbed gases are then propelled from the second contact chamber to the bottom of the third contact chamber so that the gas flows upwardly through the third contact chamber. This flow is counter-current to the liquid flow in the third contact chamber. Reagent liquids flow upward through liquid recirculation lines from each of the three sumps to their respective spray nozzles. The reagent liquids wet the packing within the contact chambers as they flow downwards. Make-up liquids are added to as the reagents are spent.

The foregoing description is illustrative and explanatory of preferred embodiments of the invention, and variations in the size, shape, materials and other details will become apparent to those skilled in the art. It is intended that all such variations and modifications which fall within the scope or spirit of the appended claims be embraced thereby.

1. A multi-stage odor scrubber comprising:
a first stage odor scrubber comprising a first contact chamber, a first sump for collecting liquids and a first recirculation pump;
a second stage odor scrubber, the second stage odor scrubber comprising a venturi chamber adjacent the first contact chamber, and a third contact chamber, the venturi chamber positioned between the first and third contact chambers, the venturi chamber comprising one or more venturi;
a unitary housing for containing the first and second stage odor scrubbers;
the second stage odor scrubber further comprising a second sump for collecting liquids and a second recirculation pump for re-circulating liquid.

2. The multi-stage odor scrubber of claim 1 wherein the first stage odor scrubber comprises a first contact chamber, means for piping contaminated gases into the first contact chamber, a first packed bed within the first contact chamber, and first chamber spray nozzles for spraying liquid into the first packed bed and the second stage odor scrubber comprises a second packed bed within the third chamber, third chamber spray nozzles for spraying liquid into the third contact chamber, and venturi chamber spray nozzles for spraying liquid into one or more venturi.

3. The multi-stage odor scrubber of claim 2 wherein the first stage further comprises a first liquid recirculation line from the first sump to the first contact chamber for re-circulating liquid in the first sump to the first chamber spray nozzles and the second stage further comprises a second liquid recirculation line from the second sump to the venturi for re-circulating liquid in the second sump to the venturi spray nozzles and a second piping means from the second liquid recirculation line to the third contact chamber spray nozzles for conveying re-circulating liquids to the third chamber spray nozzles.

4. The multi-stage odor scrubber of claim 3 further comprising a first make-up line in fluid communication with the first liquid recirculation line for conveying make-up liquids to the first contact chamber.

5. The multi-stage odor scrubber of claim 3 further comprising one or more make-up lines in fluid communication with the second piping means for conveying make-up liquids to the third contact chamber.

6. The multi-stage odor scrubber of claim 3 further comprising one or more make-up lines in fluid communication with the second liquid recirculation line for conveying make-up liquids to the venturi chamber and the third contact chamber.

7. The multi-stage odor scrubber of claim 3 wherein the third chamber spray nozzles comprise a diameter smaller in size than the diameter of the venturi spray nozzles so that a greater volume of liquid enters the venturi spray nozzles than the volume of liquid entering the third chamber spray nozzles.

8. The multi-stage odor scrubber of claim 3 wherein the second piping means comprising a diameter smaller in size than the diameter of the second liquid recirculation line so that a greater volume of liquid enters the venturi spray nozzles than the volume of liquid entering the third chamber spray nozzles.

9. The multi-stage odor scrubber of claim 1 further comprising a wall between the first sump and the second sump and a connecting pipe between the first sump and the second sump for purging spent liquids from the scrubber and transferring excess and unused liquids from the second sump to the first sump.

10. A multi-stage odor scrubber comprising:
a first stage odor scrubber, the first stage odor scrubber comprising a first contact chamber, a means for piping contaminated gases into the first contact chamber, a first packed bed within the first contact chamber, first chamber spray nozzles for spraying liquid into the first packed bed, a first sump for collecting liquids and a first recirculation pump;
a second stage odor scrubber, the second stage odor scrubber comprising a venturi chamber adjacent the first contact chamber, and a third contact chamber, the venturi chamber positioned between the first and third contact chambers, the venturi chamber comprising one or more venturi;
the third contact chamber comprising a second packed bed and third chamber spray nozzles for spraying liquid into the third contact chamber, and the venturi chamber further comprising venturi spray nozzles for spraying liquid into one or more venturi;
the second stage odor scrubber further comprising a second sump for collecting liquids from the venturi chamber and the third contact chamber, a wall between the first sump and the second sump, and a second recirculation pump for re-circulating liquid into the venturi spray nozzles and the third contact chamber spray nozzles.

11. The multi-stage odor scrubber of claim 10 wherein the first contact chamber comprises an upper and a lower section and the means for piping contaminated gases into the first contact chamber is located in the lower section.

12. The multi-stage odor scrubber of claim 10 wherein the first contact chamber and venturi define an opening so that gases from the first contact chamber flow into a top section of the venturi chamber.

13. The multi-stage odor scrubber of claim 10 wherein the one or more venturi fit snugly within the venturi chamber so that gases entering from the first contact chamber enter into the one or more venturi and the second stage odor scrubber defines a passageway beneath the venturi and third contact chamber so that gases exiting from the venturi flow into the third chamber through the passageway.

14. The multi-stage odor scrubber of claim 10 further comprising a first liquid recirculation line from the first sump to the first contact chamber for re-circulating liquid in the first sump to the first chamber spray nozzles.

15. The multi-stage odor scrubber of claim 14 further comprising a first make-up line in fluid communication with the first liquid recirculation line for conveying make-up liquids to the first contact chamber.

16. The multi-stage odor scrubber of claim 10 further comprising a second liquid recirculation line from the second sump to the venturi for re-circulating liquid in the second sump to the venturi spray nozzles.

17. The multi-stage odor scrubber of claim 10 further comprising a connecting pipe between the first sump and the second sump for purging spent liquids and transferring excess and unused liquids from the second sump to the first sump.

18. The multi-stage odor scrubber of claim 17 wherein the third chamber spray nozzles comprise a diameter smaller in size than the diameter of the venturi spray nozzles so that a greater volume of liquid from the second liquid recirculation line enters the venturi spray nozzles than the volume of liquid entering the third chamber spray nozzles.

19. The multi-stage odor scrubber of claim 17 further comprising a second piping means from the second liquid recirculation line to the third contact chamber spray nozzles for conveying re-circulating liquids to the third chamber spray nozzles, the second piping means comprising a diameter smaller in size than the diameter of the second liquid recirculation line so that a greater volume of liquid enters the venturi spray nozzles than the volume of liquid entering the third chamber spray nozzles.

20. The multi-stage odor scrubber of claim 19 further comprising one or more make-up liquid lines in fluid communication with the second piping means for conveying make-up liquids to the third contact chamber.

21. The multi-stage odor scrubber of claim 19 further comprising one or more make-up lines in fluid communication with the second liquid recirculation line for conveying make-up liquids to the venturi chamber and the third contact chamber.

22. The multi-stage odor scrubber of claim 10 wherein the gases comprise contaminants and the liquid sprayed into the venturi chamber and first and third contact chambers comprises reagents for removing the contaminants.

23. The multi-stage odor scrubber of claim 10 wherein the first contact chamber and the third contact chamber each comprise a mist eliminator for removing moisture from the gases prior to the gases leaving the respective contact chambers.

24. The multi-stage odor scrubber of claim 10 wherein the third contact chamber defines a discharge outlet for discharging scrubbed gases.

25. The multi-stage odor scrubber of claim 10 wherein the flow of gas in the first contact chamber and third contact chamber is counter-current to the flow of liquid.

26. The multi-stage odor scrubber of claim 10 wherein the flow of gas in the venturi chamber is co-current with the flow of liquid.

27. A multi-stage odor scrubber comprising:
a first stage odor scrubber, the first stage odor scrubber comprising a first contact chamber, a gas inlet for piping contaminated gases into the first contact chamber, a first packed bed within the first contact chamber, first chamber liquid spray nozzles for spraying liquid into the first packed bed, a first sump for collecting liquids, a first liquid recirculation line for conveying re-circulating liquids and make-up liquids to the first chamber spray nozzles and a first recirculation pump;
a second stage odor scrubber, the second stage odor scrubber comprising a second contact chamber, the first and second contact chambers defining an opening for transmitting contaminated gases into the second contact chamber, a second packed bed within the second contact chamber, second chamber liquid spray nozzles for spraying liquid into the second packed bed, a second sump for collecting liquids, a second liquid recirculation line for conveying re-circulating liquids to the second chamber spray nozzles and a second recirculation pump;
a third stage odor scrubber, the third stage odor scrubber comprising a third contact chamber, the second and third contact chambers defining an second opening for transmitting contaminated gases into the third contact chamber, a third packed bed within the third contact chamber, third chamber liquid spray nozzles for spraying liquid into the third packed bed, a third sump for collecting liquids, a third liquid recirculation line for conveying re-circulating liquids and make-up liquids to the third chamber spray nozzles and a third recirculation pump; and
a unitary housing for containing the first stage odor scrubber, the second stage odor scrubber and the third stage odor scrubber.

28. The multi-stage odor scrubber of claim 27 wherein the first contact chamber and the third contact chamber further comprise a mist eliminator for removing moisture from the gases prior to the gases leaving the respective contact chambers.

29. The multi-stage odor scrubber of claim 27 wherein the third contact chamber defines a discharge outlet for discharging scrubbed gases.

30. The multi-stage odor scrubber of claim 27 wherein the flow of gas in the first contact chamber and the third contact chamber is counter-current to the flow of liquid.

31. The multi-stage odor scrubber of claim 25 further comprising a first wall between the first and second sumps, a second wall between the second and third sumps, a first connecting pipe between the first sump and the second sump and a second connecting pipe between the second sump and the third sump for purging spent liquids from the scrubber and conveying excess and unused liquids forward from the third sump to the second sump, and from the second sump to the first sump.

32. A method for removing contaminants from a gas stream comprising:
a. propelling a contaminated gas stream through a multi-stage odor scrubber, the multi-stage odor scrubber comprising a first packed chamber, first chamber spray nozzles, a third packed chamber with third chamber spray nozzles, and a venturi chamber between the first and third packed chambers, the venturi chamber comprising one or more venturi and venturi spray nozzles for each venturi, the contaminated gas propelled upwardly through the first packed chamber;
b. pumping one or more reagent liquids through the first packed chamber from a first sump below the chamber to the first set of spray nozzles;
c. pumping one or more reagent liquids through the venturi chamber and third packed chamber from a second sump below the chamber to the venturi spray nozzles and third chamber spray nozzles;
d. continuing to propel the partially scrubbed gas upward in the first packed chamber so that the gas exits from a slot within an upper wall of the first packed chamber into the top of the venturi chamber and flows downward through the one or more venturi co-currently with the reagent liquid from the venturi spray nozzles; and
e. propelling the partially scrubbed gas from the venturi to a bottom of the third chamber so that the gas flows upwardly through the third packed chamber and counter-current to the reagent liquid flow in the third packed chamber.

33. The method of claim 32 further comprising the step of piping reagent liquid upward through a first liquid recirculation line from the first sump to the first chamber spray nozzles within a top section of the first packed chamber so that the reagent liquid flows downward through the packed chamber counter-current to the gas, and re-collects in the first sump.

34. The method of claim 32 further comprising pumping one or more reagent liquids from a second sump through a recirculation line to one or more venturi spray nozzles within the top section of the venturi chamber and piping another portion of the reagent liquids from the recirculation line through a second piping means to the third chamber spray nozzles so that the reagent liquids flow downward through the packed chamber counter-current to the gas and rec-collect in the second sump.

35. The method of claim 34 wherein the portion of reagent liquid entering the third chamber spray nozzles is smaller than the portion of liquid entering the one or more venturi spray nozzles.

36. The method of claim 35 further comprising adding one or more make-up reagents to the re-circulating liquid pipeline before the flow of liquid into the third contact chamber.

37. The method of claim 34 further comprising adding one or more make-up reagents to the second piping means.

38. The method of claim 32 wherein a first reagent is piped into the first liquid reagent line and a first reagent and a second reagent are piped into the second liquid recirculation line.

39. A method for removing contaminants from a gas stream comprising:
a. propelling a contaminated gas stream through a multi-stage odor scrubber, the multi-stage odor scrubber comprising a first contact chamber, a third contact chamber and a venturi chamber between the first and third chambers, the first contact chamber and the third contact chamber comprising packed chambers, the venturi chamber comprising one or more venturi, the contaminated gas propelled upwardly through the first packed chamber, downwardly through the venturi chamber and upwardly through the third contact chamber;
b. pumping one or more reagent liquids upwards through a first liquid recirculation line from a first sump to first chamber spray nozzles within a top section of the first packed chamber so that the reagent liquid flows through the first packed chamber counter-current to the gas, and collects in the first sump;
c. pumping one or more reagent liquids upwards from a second sump through a second recirculation pipeline to one or more venturi spray nozzles within the top section of the venturi chamber so that the one or more reagent liquids flow co-currently to the gas and collect in the second sump, piping a portion of the reagent fluid from the recirculation line to third chamber spray nozzles within the top of the third contact chamber, the portion piped to the third contact chamber smaller than the portion entering the one or more venturi spray nozzles;
d. allowing the reagent liquid to flow downward from the spray nozzles within the venturi chamber and the second packed chamber to collect within the second sump for recirculation back to the spray nozzles;
e. propelling the gas upward in the first packed chamber so that the gas exits from a slot within an upper wall of the first packed chamber into the top of the venturi chamber and flows downward through the one or more the venturi co-currently with the liquid from the venturi spray nozzles; and
f. propelling the partially scrubbed gas from the venturi chamber to a bottom of the third chamber so that the gas flows upwardly through the second packed chamber and counter-current to the liquid flow in the third chamber;

40. The method of claim 39 further comprising the step of adding make-up liquid to the first contact chamber.

41. The method of claim 39 further comprising adding one or more make-up liquids to the second liquid recirculation line before the flow of liquid into the third contact chamber.

42. The method of claim 39 further comprising adding one or more make-up liquids to the third contact chamber.
